(19) United States
(12) Patent Application Publication
(10) Pub. No.: US 2019/0124654 A1
(43) Pub. Date: Apr. 25, 2019

(54) SCHEDULING, TRANSMISSION, AND RECEPTION OF ACKNOWLEDGEMENT MESSAGES

(71) Applicant: QUALCOMM Incorporated, San Diego, CA (US)

(72) Inventors: George CHERIAN, San Diego, CA (US); Solomon TRAININ, Haifa (IL); Lochan VERMA, San Diego, CA (US); Alfred ASTERJADHI, San Diego, CA (US); Abhishek Pramod PATIL, San Diego, CA (US)

(21) Appl. No.: 16/159,538

(22) Filed: Oct. 12, 2018

Related U.S. Application Data
(60) Provisional application No. 62/576,070, filed on Oct. 23, 2017.

(51) Int. Cl. H04W 72/04; H04L 1/16; H04W 72/12; H04W 80/08

(52) U.S. Cl. CPC H04W 72/0446; H04L 1/1657; H04W 80/08; H04W 72/1226; H04L 1/1671

(57) ABSTRACT

A method and an apparatus for wireless communication are provided. In one configuration, a first device may receive from a second device information indicative of a slot schedule for scheduling communication between the two devices. The slot schedule may allocate slots for the first device to transmit to the second device and for the second device to transmit to the first device. The information may indicate one or more types of message allowed or disallowed to be transmitted in the respective slots. The first device may determine based on the received information a chronologically first slot that is a first slot in time among all the slots allocated to the first device allowed to transmit an acknowledgement message. The first device may receive a first message from the second device. The first device may transmit an acknowledgement message in response to the received first message using the chronologically first slot.

This application claims the priority benefit of U.S. Provisional Application Ser. No. 62/576,070, entitled “SCHEDULING, TRANSMISSION, AND RECEPTION OF ACKNOWLEDGEMENT MESSAGES” and filed on Oct. 23, 2017, which is expressly incorporated by reference herein in its entirety.

### TECHNICAL FIELD

The present disclosure relates generally to communication systems, and more particularly, to scheduling, transmission, and/or reception of acknowledgement messages and other types of control response messages.

### DESCRIPTION OF THE RELATED TECHNOLOGY

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One aspect of this disclosure provides a method for wireless communication.

The method may include receiving by a first device from a second device a slot schedule for scheduling communication between the first device and the second device of a plurality of devices using a plurality of slots of a frame. The plurality of devices may include the first device and the second device. The slot schedule may include respective first information for each slot of the plurality of slots. The respective first information for a slot may indicate one or more types of messages allowed or disallowed to be transmitted in the slot. The slot schedule may further include a first transmission slot reserved for the second device to transmit information to the first device and a plurality of reception slots reserved for the first device to transmit information to the second device. The method may include the first device determining, based on the slot schedule, a chronologically first reception slot that is positioned in time before any other reception slot of the plurality of reception slots indicated by the respective first information as being allowed to be used by the first device to transmit an acknowledgement message to the second device. The method may include the first device receiving, from the second device, a first message during the first transmission slot. The method may further include the first device transmitting, to the second device, a first acknowledgement message in response to reception of the first message during the chronologically first reception slot among the plurality of reception slots.

Another aspect of this disclosure provides a method for wireless communication. The method may include transmitting by a first device to a second device a slot schedule for scheduling communication between the first device and the second device of a plurality of devices using a plurality of slots of a frame. The plurality of devices may include the first device and the second device. The slot schedule may include respective first information for each slot of the plurality of slots. The respective first information for a slot may indicate one or more types of messages allowed or disallowed to be transmitted in the slot. The slot schedule may further include a first transmission slot reserved for the first device to transmit information to the second device and a plurality of reception slots reserved for the second device to transmit information to the first device. The plurality of reception slots may include a chronologically first reception slot positioned in time before any other reception slot of the plurality of reception slots indicated by the respective first information as being allowed to be used by the second device to transmit an acknowledgement message to the first device. The method may include the first device transmitting, to the second device, a first message during the first transmission slot. The method may further include the first device receiving, from the second device, a first acknowledgement message to the first message during the chronologically first reception slot among the plurality of reception slots.

Another aspect of this disclosure provides a first apparatus (e.g., an access point, a station, or other wireless communication device) for wireless communication. The first apparatus may include one or more antennas, one or more processors, and one or more memories storing processor readable code that, when executed by the one or more processors, configures the first apparatus to receive, from a second apparatus, a slot schedule for scheduling communication between the first apparatus and the second apparatus of a plurality of apparatuses using a plurality of slots of a frame. The plurality of apparatuses may include the first apparatus and the second apparatus. The slot schedule may include a first transmission slot reserved for the second apparatus to transmit information to the first apparatus and a plurality of reception slots reserved for the first apparatus to transmit information to the second apparatus. The slot schedule may further include respective first information for each slot of the plurality of slots. The respective first information for a slot may indicate one or more types of messages allowed or disallowed to be transmitted in the respective slot. The first apparatus may be also configured to determine a chronologically first reception slot that is positioned in time before any other reception slot of the plurality of reception slots indicated by the respective first information as being allowed to be used by the first apparatus to transmit an acknowledgement message to the second apparatus. The first apparatus may be configured to receive, from the second apparatus, a first message during the first transmission slot. The first apparatus may be configured to transmit, to the second apparatus, a first acknowledgement message in response to the reception of the first message during the chronologically first reception slot based on the determination that the chronologically first reception slot is chronologically first among the plurality of reception slots indicated by the respective first information as being allowed to be used by the first apparatus to transmit an acknowledgement message to the second apparatus.

Another aspect of this disclosure provides a first apparatus (e.g., an access point, a station, or other wireless communication device) for wireless communication. The first apparatus may include one or more antennas, one or more processors, and one or more memories storing processor readable code that, when executed by the one or more processors, configures the first apparatus to transmit, to a second apparatus, a slot schedule for scheduling communication between the first apparatus and the second apparatus of a plurality of apparatuses using a plurality of slots of a frame. The plurality of apparatuses may include the first apparatus and the second apparatus The slot schedule may include a first transmission slot reserved for the first apparatus to transmit information to the second apparatus and a plurality of reception slots reserved for the second apparatus to transmit information to the first apparatus. The slot schedule may further include respective first information for each slot of the plurality of slots. The respective first information for a slot may indicate one or more types of messages allowed or disallowed to be transmitted in the respective slot. The plurality of reception slots may include a chronologically first reception slot positioned in time before any other reception slot of the plurality of reception slots indicated by the respective first information as being allowed to be used by the second apparatus to transmit an acknowledgement message to the first apparatus. The first apparatus may be configured to transmit, to the second apparatus, a first message during the first transmission slot. The first apparatus may be configured to receive, from the second apparatus, a first acknowledgement message to the first message during the chronologically first reception slot based on the chronologically first reception slot being chronologically first among the plurality of reception slots indicated by the respective first information as being allowed to be used by the second apparatus to transmit an acknowledgement message to the first apparatus.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communication system in accordance with the techniques described herein.

FIGS. 2A-2I illustrates various examples of slot schedules and use cases.

FIG. 3 shows an example functional block diagram of a wireless device configured to perform one or more techniques described herein.

FIG. 4A is a flowchart of an example method in accordance with the techniques described herein.

FIG. 4B is a flowchart of an example method in accordance with the techniques described herein.

FIG. 4C is a flowchart of an example method in accordance with the techniques described herein.

FIG. 4D is a flowchart of an example method in accordance with the techniques described herein.

### DETAILED DESCRIPTION

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer-readable media, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Aspects of the disclosure are described herein using the terms slots, and in particular transmission slots and reception slots. A slot may refer to a time interval within a TDD (time-domain duplex) frame assigned to a device to communicate with another device. A slot allows simplex communication, e.g., either transmission or reception, but not both. A transmission slot may refer to a time period during which an assigned device may be configured to transmit information to another assigned device. For example, a transmission slot may refer to a time period that is reserved for a first assigned device to transmit information to a second assigned device. Similarly, as used herein, a reception slot may refer to a time period during which an assigned device may be configured to receive information from another assigned device. As an example, and continuing with the first assigned device and second assigned device example above, a reception slot may refer to a time period that is reserved for the first assigned device to receive information from the assigned device. Therefore, it is understood that the use of “transmission” and “reception” to describe a slot depends on which of the two devices assigned thereto is the focus. For example, and continuing with the first assigned device and second assigned device example above, the transmission slot may refer to a time period that is reserved for the first assigned device to transmit information to the second assigned device. However, this same time period (i.e., the time period corresponding to the transmission slot) refers to the time period that is reserved for the second assigned device to receive information from the first assigned device. Similarly, with respect to the reception slot, the reception slot may refer to a time period that is reserved for the first assigned device to receive information from the second assigned device. However, this same time period (i.e., the time period corresponding to the reception slot) refers to the time period that is reserved for the second assigned device to transmit information to the first assigned device. Therefore, in some examples, a slot may be referred to as having a polarity, such as a transmission polarity or a reception polarity.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices, such access points (APs) and clients (also referred to as stations or “STAs”). In other examples, two types of devices may include distribution nodes (DNs) and client nodes (CNs). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP. In this regard, a STA may be described as an AP or a non-AP STA. While an AP and a STA are described herein, these are examples of devices that may be configured to perform one or more techniques described herein. For example, reference to an AP may include reference to a distribution node, and reference to a STA may include reference to a client node. As another example, reference to an AP may include reference to a first device and reference to a STA may include reference to a second device. As another example, reference to a STA may include reference to a first device and reference to an AP may include reference to a second device.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, distribution node (DN), or some other terminology.

A station may also comprise, be implemented as, or known as an access terminal (AT), a subscriber station, a subscriber unit, a mobile station, a remote station, a remote terminal, a user terminal, a user agent, a user device, a user equipment, a client node (CN), or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

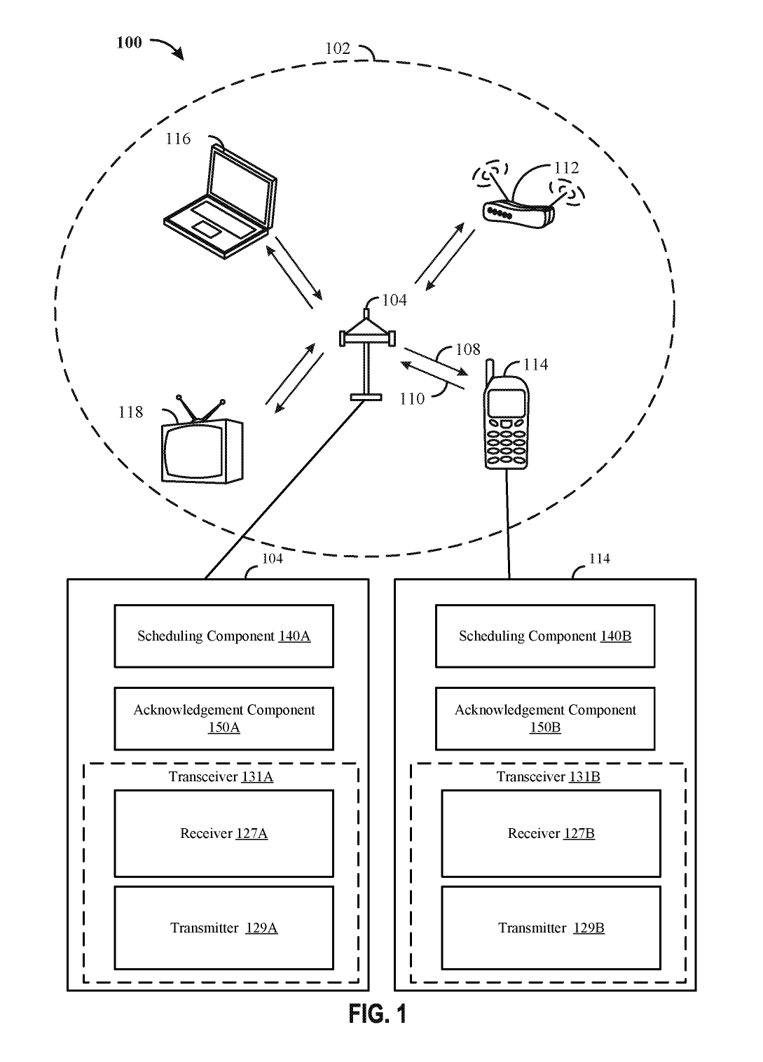

FIG. 1 illustrates an example wireless communication system 100 in which one or more techniques described herein may be employed. The wireless communication system 100 may operate pursuant to a wireless standard, for example the IEEE 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDMA/MU-MIMO techniques. In such a case, the wireless communication system 100 may be referred to as an OFDMA/MU-MIMO system. Alternatively, signals may be sent and received between the AP 104 and the STAs in accordance with CDMA techniques. In such a case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast traffic (e.g., communications), multicast traffic, and/or broadcast traffic.

In some aspects, the AP 104 may suppress adjacent channel interference (ACI) so that the AP 104 may receive UL communications on more than one channel concurrently while reducing analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) may be the coverage area of an AP (e.g., the AP 104). The AP 104 along with the STAs associated with the AP 104 and that use the AP 104 for communication may be referred to as a basic service set (BSS). The wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a page signal (or simply a “page”), via a communication link such as the downlink 108, to other nodes (STAs) of the wireless communication system 100. The page signal may help the other nodes (STAs) synchronize their timing with the AP 104. Alternatively or additionally, the page signal may provide other information or functionality. Such pages may be transmitted periodically. In one aspect, the period between successive transmissions of a page may be referred to as a superframe. Transmission of a page may be divided into a number of groups or intervals. In one aspect, the page may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a page may include information that is common (e.g., shared) amongst several devices and/or information specific to a given device.

In some examples, a STA (e.g., STA 114) may associate with the AP 104 in order to send communications to and/or to receive communications from the AP 104. In one aspect, information for associating may be included in a page broadcast by the AP 104. To receive such a page, the STA 114 may, for example, perform a broad coverage search over a coverage region. A search may also be performed by the STA 114 by sweeping a coverage region in a lighthouse fashion, for example. After receiving the information for associating, the STA 114 may transmit, for example, an association probe or request, to the AP 104. In some aspects, the AP 104 may use backhaul services, for example, to communicate with a larger network, such as the Internet or a public switched telephone network (PSTN).

In some examples, the AP 104 may include one or more components (or circuits) for performing various functions described herein. The AP 104 includes a receiver 127A and a transmitter 129A. The receiver 127A may be configured to perform any receiving function described herein with respect to the AP 104. For example, the receiver 127A may be configured to receive information indicative of a slot schedule, one or more messages from another device (e.g., non-acknowledgement message), and/or one or more acknowledgement messages from another device in accordance with the techniques described herein. The transmitter 129A may be configured to perform any transmitting function described herein with respect to the AP 104. For example, the transmitter 129A may be configured to transmit information indicative of a slot schedule, one or more messages from the AP 104 (e.g., non-acknowledgement message), and/or one or more acknowledgement messages from the AP 104 in accordance with the techniques described herein. The receiver 127A and the transmitter 129A may be combined into a transceiver 131A. In such examples, the transceiver 131A may be configured to perform any receiving function and/or transmitting function described herein with respect to the AP 104.

In some examples, the AP 104 may include a scheduling component 140A and an acknowledgement (ACK) component 150A. The scheduling component 140A may be configured to perform any processing (e.g., functions, steps, or the like) described herein with respect to scheduling information. The scheduling component 140A may be configured to generate scheduling information. In some examples, the scheduling component 140A may be configured to generate one or more messages (e.g., one or more frames) that include the scheduling information, such as any slot scheduling information described herein. In some examples, a single scheduling message may include all scheduling information. In other examples, a first scheduling message may include less than all scheduling information. In such examples, one or more additional scheduling messages together with the first scheduling message may include all the scheduling information. The scheduling information may include information indicative of a slot schedule for scheduling communication between a plurality of devices. A TDD frame may include a plurality of slots. Each slot may be reserved for a respective device of a plurality of devices. The plurality of slots may include at least one transmission slot and a plurality of reception slots. The transmitter 129A may be configured to transmit scheduling information generated by the scheduling component 140A. For example, the transmitter 129A may be configured to receive scheduling information from the scheduling component 140A and to transmit the received scheduling information. One or more devices (e.g., e.g., one or more STAs and/or one or more APs) may receive the scheduling information, and operate in accordance therewith. For example, each device of the one or more devices that receive the scheduling may be configured to only transmit information during a transmission slot assigned thereto. In some examples, the scheduling component 140A may be configured to control the AP 104 to operate in accordance with any scheduling information, such as a slot schedule generated by the scheduling component 140A and/or scheduling information received from another device. For example, the receiver 127A may receive scheduling information from another device (e.g., a STA such as STA 114 or another AP). The receiver 127A may provide the received scheduling information to the scheduling component 140A. The scheduling component 140A may be configured to control the AP 104 to operate in accordance with the received scheduling information.

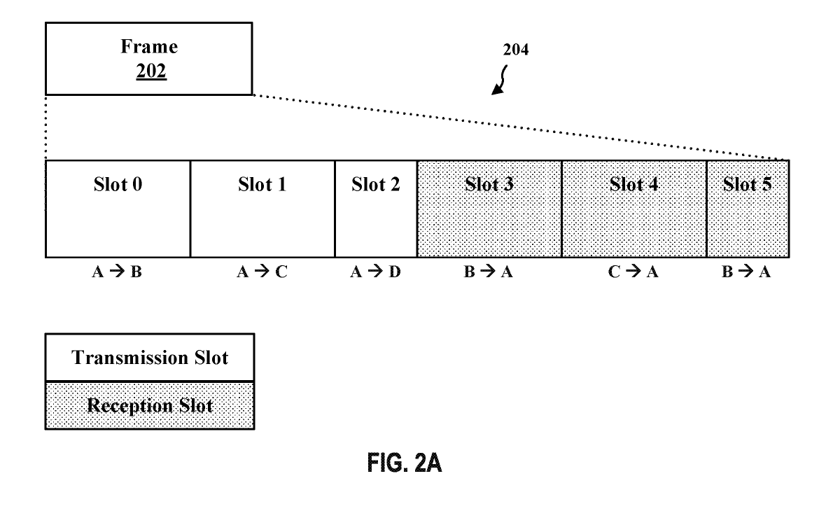

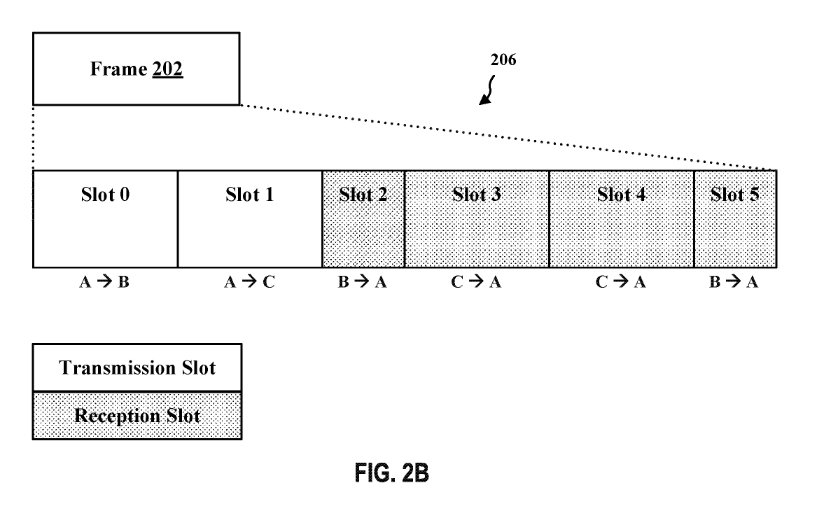

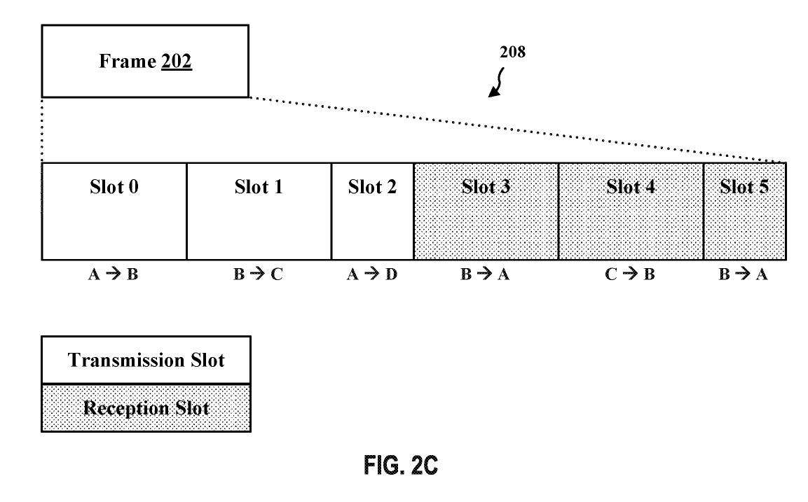

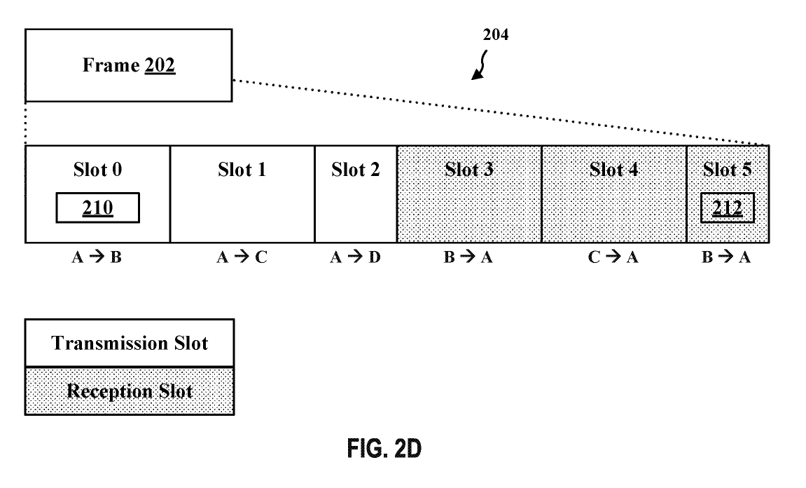

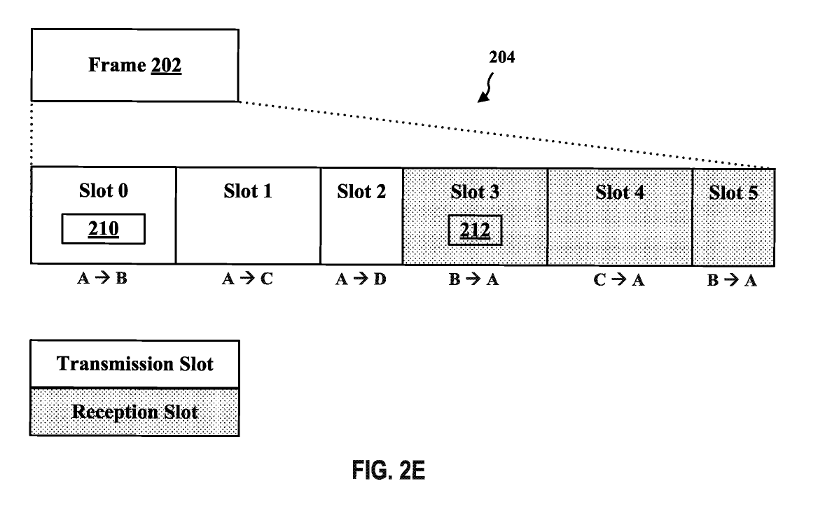

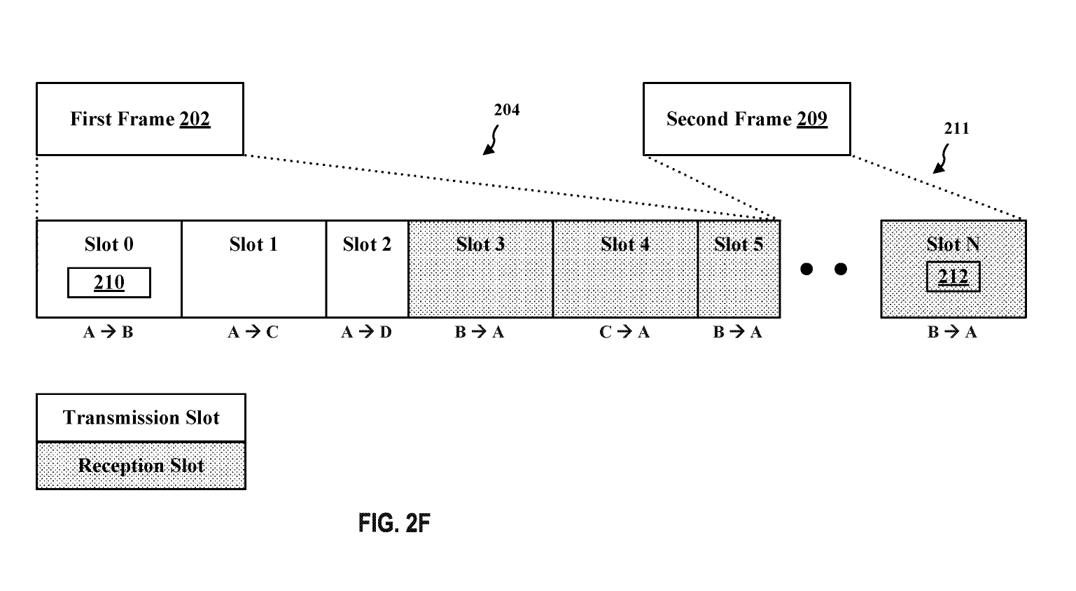

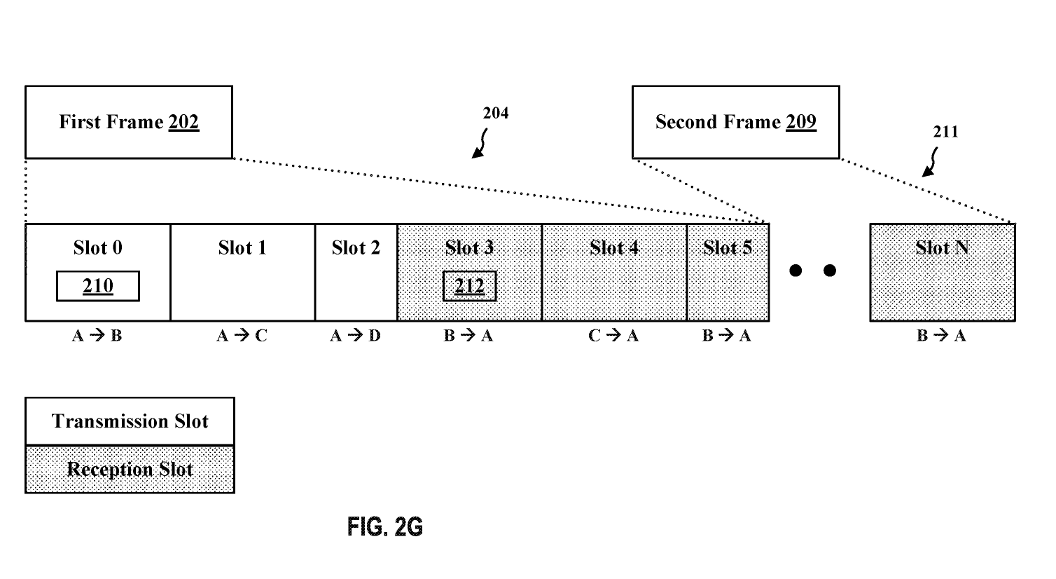

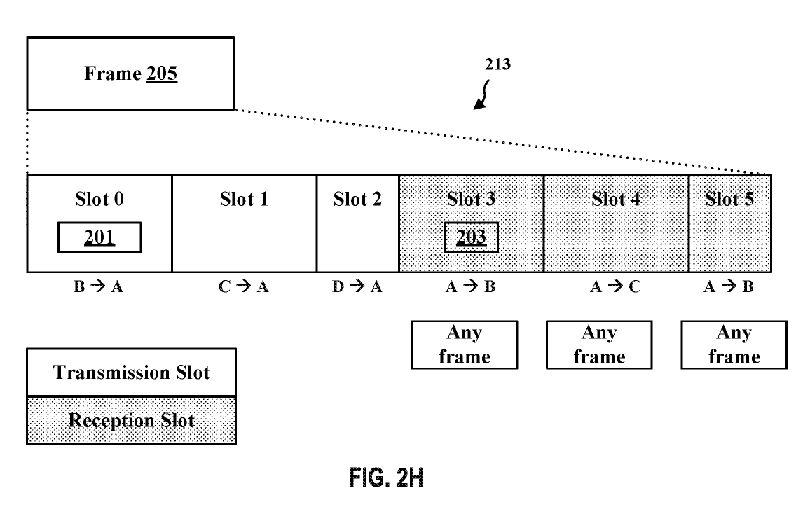

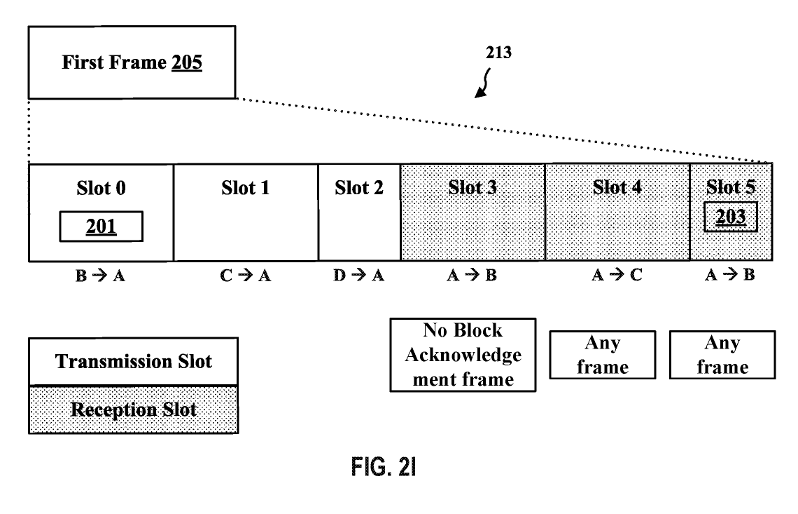

FIG. 2A illustrates one example of a slot schedule 204 for the plurality of slots of a TDD frame 202. In the example of FIG. 2A, an AP, e.g., AP 104, may transmit to one or more STAs. e.g., STA 114, 116, information indicative of the slot structure and the slot schedule 204. For example, the slot structure information may include information indicative of a number of slots included in the TDD frame 202. In the example of FIG. 2A, the TDD frame 202 includes six slots. The slot structure information may also include information indicative of a respective time period corresponding to each slot of TDD frame 202. In the example of FIG. 2A, such information may include the respective time periods for slots 0, 1, 2, 3, 4, and 5. For example, slots 0, 1, 3, and 4 are shown as each having a longer time period than the time periods of slots 2 and 5. The slot schedule information may include information that identifies which respective device(s) of the plurality of devices is assigned to each respective slot of the TDD frame 202. In the example of FIG. 2A, if A designates the AP, the slot schedule 204 indicates that device B (e.g., a STA) is assigned to slot 0 with device A being the transmission device and device B being the assigned reception device. Continuing with the example of FIG. 2A, the slot schedule 204 may indicate that device C is assigned to slot 1 with device A being the transmission device and device C being the assigned reception device, device D is assigned to slot 2 with device A being the transmission device and device D being the assigned reception device, device B is assigned to slot 3 with device A being the reception device and device B being the assigned transmission device, device C is assigned to slot 4 with device A being the reception device and device C being the assigned transmission device, and device B is assigned to slot 5 with device A being the reception device and device B being the assigned transmission device. In some examples, slots 0, 1, and 2 may be referred to as transmission slots and slots 3, 4, and 5 may be referred to as reception slots, with the focus being on device A.

The example of FIG. 2A also illustrates that slot 3 is the chronologically first reception slot positioned before any other reception slot of the plurality of reception slots (in this example, the plurality of reception slots including slots 3, 4, and 5) in the slot schedule 204. Slot 3 is also the chronologically first reception slot between the reception slots assigned to device B in the slot schedule 204 (i.e., slot 3 is positioned before any other slot assigned to device B, which is slot 5 in the example FIG. 2A).

FIG. 2B illustrates another example of a slot schedule 206 for the slots of the TDD frame 202. In this example, slot 2 is the chronologically first reception slot between the reception slots assigned to device B in the slot schedule 206 (i.e., slot 2 is positioned before any other slot assigned to device B, which is slot 5 in the example FIG. 2B), and slot 3 is the chronologically first reception slot between the reception slots assigned to both device C in the slot schedule 206 (i.e., slot 3 is positioned before any other slot assigned to device C, which is slot 4 in the example FIG. 2B).

In some examples, a slot schedule may have one common device to each slot (such as device A in the examples of FIGS. 2A and 2B). However, in other examples, a slot schedule may not have one common device to each slot, such as in the example slot schedule 208 illustrated in FIG. 2C. In some examples, the AP 104 may be device A identified in FIGS. 2A-2I and the STA 114 may be device B identified in FIGS. 2A-2I. In other examples, the AP 104 may be device B identified in FIGS. 2A-2I and the STA 114 may be device A identified in FIGS. 2A-2I.

Referring back to FIG. 1, the ACK component 150A may be configured to perform any processing (e.g., functions, steps, or the like) described herein with respect to any acknowledgement message. For example, the ACK component 150A may be configured to generate an acknowledgement message in accordance with the techniques described herein. As an example, the ACK component 150A may be configured to generate an acknowledgement message in response to a trigger event. The trigger event may include receipt of a message. The ACK component 150A may be configured to provide the generated acknowledgement message to the transmitter 129A based on slot scheduling information. For example, the ACK component 150A may be configured to determine, based on the slot scheduling information, the time slot during which the acknowledgement message may be transmitted, and may provide the acknowledgement message to the transmitter 129A at the appropriate time to ensure the acknowledgement message is transmitted during the assigned time slot. In other examples, the ACK component 150A may provide the generated acknowledgement message to the scheduling component 140A. The scheduling component 140A may be configured to determine, based on the slot scheduling information, the time slot during which the acknowledgement message may be transmitted, and may provide the acknowledgement message to the transmitter 129A at the appropriate time to ensure the acknowledgement message is transmitted during the assigned time slot. Otherwise described, the scheduling component 140A may be configured to provide the generated acknowledgement message to the transmitter 129A based on the slot scheduling information. The transmitter 129A may be configured to transmit the acknowledgement message generated by the ACK component 150A. In another aspect of the disclosure, the ACK component 150A may be configured to generate a control response message other than an acknowledgement message in accordance with the techniques described herein.

In some examples, the STA 114 may include one or more components (or circuits) for performing various functions described herein. The STA 114 includes a receiver 127B and a transmitter 129B. The receiver 127B may be configured to perform any receiving function described herein with respect to the STA 114. For example, the receiver 127B may be configured to receive information indicative of a slot schedule, one or more messages from another device (e.g., non-acknowledgement message), and/or one or more acknowledgement messages from another device in accordance with the techniques described herein. The transmitter 129B may be configured to perform any transmitting function described herein with respect to the STA 114. For example, the transmitter 129B may be configured to transmit one or more messages from the STA 114 (e.g., non-acknowledgement message), and/or one or more acknowledgement messages from the STA 114 in accordance with the techniques described herein. The receiver 127B and the transmitter 129B may be combined into a transceiver 131B. In such examples, the transceiver 131B may be configured to perform any receiving function and/or transmitting function described herein with respect to the STA 114.

In some examples, the STA 114 may include a scheduling component 140B and an acknowledgement (ACK) component 150B. The scheduling component 140B may be configured to perform any processing (e.g., functions, steps, or the like) described herein with respect to scheduling information. The scheduling component 140B may be configured to generate scheduling information. In some examples, the scheduling component 140B may be configured to receive or to generate one or more messages (e.g., one or more frames) that include the scheduling information, such as any slot scheduling information described herein. In some examples, a single scheduling message may include all scheduling information. In other examples, a first scheduling message may include less than all scheduling information. In such examples, one or more additional scheduling messages together with the first scheduling message may include all the scheduling information. The scheduling information may include information indicative of a slot schedule for scheduling communication between a plurality of devices. A TDD frame may include a plurality of slots. Each slot may be reserved for a respective device of a plurality of devices. The plurality of slots may include at least one transmission slot and a plurality of reception slots. The transmitter 129B may be configured to transmit scheduling information generated by the scheduling component 140B. For example, the transmitter 129B may be configured to receive scheduling information from the scheduling component 140B and to transmit the received scheduling information. One or more devices (e.g., e.g., one or more STAs and/or one or more APs) may receive the scheduling information, and operate in accordance therewith. For example, each device of the one or more devices that receive the scheduling information may be configured to only transmit information during a transmission slot assigned thereto. In some examples, the scheduling component 140B may be configured to control the STA 114 to operate in accordance with any scheduling information, such as a slot schedule generated by the scheduling component 140B and/or scheduling information received from another device. For example, the receiver 127B may receive scheduling information from another device (e.g., another STA or an AP, such as AP 104). The receiver 127B may provide the received scheduling information to the scheduling component 140B. The scheduling component 140B may be configured to control the STA 114 to operate in accordance with the received scheduling information.

The ACK component 150B may be configured to perform any processing (e.g., functions, steps, or the like) described herein with respect to any acknowledgement message. For example, the ACK component 150B may be configured to generate an acknowledgement message in accordance with the techniques described herein. As an example, the ACK component 150B may be configured to generate an acknowledgement message in response to a trigger event. The trigger event may include receipt of a message. The ACK component 150B may be configured to provide the generated acknowledgement message to the transmitter 129B based on slot scheduling information. For example, the ACK component 150B may be configured to determine, based on the slot scheduling information, the time slot during which the acknowledgement message may be transmitted, and may provide the acknowledgement message to the transmitter 129B at the appropriate time to ensure the acknowledgement message is transmitted during the assigned time slot. In other examples, the ACK component 150B may provide the generated acknowledgement message to the scheduling component 140B. The scheduling component 140B may be configured to determine, based on the slot scheduling information, the time slot during which the acknowledgement message may be transmitted, and may provide the acknowledgement message to the transmitter 129B at the appropriate time to ensure the acknowledgement message is transmitted during the assigned time slot. Otherwise described, the scheduling component 140B may be configured to provide the generated acknowledgement message to the transmitter 129A based on the slot scheduling information. The transmitter 129B may be configured to transmit the acknowledgement message generated by the ACK component 150B. In another aspect of the disclosure, the ACK component 150B may be configured to generate a control response message other than an acknowledgement message in accordance with the techniques described herein.

FIG. 2D illustrates one example use case of the slot schedule 204 illustrated in FIG. 2A. During slot 0, device A transmits message 210 to device B. To acknowledge receipt of the message 210, device B is configured to transmit an acknowledgement message 212 to device A. However, in the example of FIG. 2D, device B transmits the acknowledgement message 212 to device A during slot 5 instead of the chronologically first reception slot assigned to device B in the slot schedule 204 (i.e., slot 3). In some examples, device B may be configured to do so because slot 5 is smaller than slot 3 (i.e., has a length less than slot 3). This configuration places priority on data (as opposed to acknowledgement messages) because by delaying the transmission of the acknowledgement message 212 to slot 5, this may allow more data to be transmitted in slot 3. However, in accordance with some example techniques described herein, device B may be configured to transmit the acknowledgement message 212 to device A during the chronologically first reception slot assigned to device B in the slot schedule 204, such as in the example shown in FIG. 2E The configuration shown in FIG. 2D does not take into account that the size of the acknowledgement message 212 may be negligible; and, as a result may improperly place priority on data transmission while running the risk the acknowledgement message 212 not being timely transmitted (i.e., device A may not receive the acknowledgement message 212 within a timeout period; and, as a result, would retransmit the message 210 despite the message 210 having been received by device B).

As described herein, a device may be configured to transmit a message to another device. Upon transmitting the message, the device may be configured to initiate a timeout timer that is a period of time in length. If the device does not receive an acknowledgement message from the other device before expiration of the timeout timer, the device may be configured to re-transmit the message to the other device again. The acknowledgement message may correspond to the message being acknowledged. For example, acknowledgement to a Quality of Service (QoS) data frame may include a normal acknowledgement (i.e., not a block acknowledgement message). In such an example, the message 210 may be a QoS data frame and the acknowledgement message 212 may be a normal acknowledgement. As another example, acknowledgement to a probe request may include a probe response. In such an example, the message 210 may be a probe request and the acknowledgement message 212 may be an acknowledgement to the probe request. As another example, acknowledgement to an aggregated medium access control (MAC) protocol data unit (A-MPDU) may include a block acknowledgement. In such an example, the message 210 may be an A-MPDU and the acknowledgement message 212 may be a block acknowledgement. As another example, acknowledgement to a MAC protocol data unit (MPDU) may include a normal acknowledgement (i.e., not a block acknowledgement message). In such an example, the message 210 may be an MPDU and the acknowledgement message 212 may be a normal acknowledgement (i.e., not a block acknowledgement message).

FIG. 2F illustrates another example use case of the slot schedule 204 illustrated in FIG. 2A. During slot 0, device A transmits message 210 to device B. To acknowledge receipt of the message 210, device B is configured to transmit an acknowledgement message 212 to device A. However, in the example of FIG. 2F, device B transmits the acknowledgement message 212 to device A during a slot (i.e., slot N in the illustrated example) corresponding to a subsequent slot schedule 211 of a second frame 209. In some examples, the slot schedule 211 may include one or more transmission slots before slot N, one or more reception slots before slot N, and/or one or more reception slots after slot N. Similar to the potential timeout issue in the example of FIG. 2D, waiting until slot N to transmit the acknowledgement message 212 may cause device A to falsely timeout with respect to the message 210, resulting in re-transmission of the message 210 by device A despite successful receipt by device B. However, in accordance with some example techniques described herein, device B may be configured to transmit the acknowledgement message 212 to device A during the chronologically first reception slot assigned to device B in the slot schedule 204, such as in the example shown in FIG. 2G. The configuration shown in FIG. 2F does not take into account that the size of the acknowledgement message 212 may be negligible; and, as a result may improperly place priority on data transmission while running the risk the acknowledgement message 212 not being timely transmitted (i.e., device A may not receive the acknowledgement message 212 within a timeout period; and, as a result, would retransmit the message 210 despite the message 210 having been received by device B).

In one aspect, the timeout timer may be configured to be variable to eliminate or reduce the probability of the false timeout if a device could anticipate the delay between the transmission of a message and the reception of an acknowledgement message. However, it may be difficult to tailor the slot duration to allow a device to transmit an acknowledgement message during the chronologically first reception slot assigned to the device without compromising the transmission throughput from the device. For example, the chronologically first reception slot could have been used by the assigned device to transmit data instead of the short block acknowledgement message. Therefore, in one aspect of the disclosure, a slot may have a slot classifier that indicates the type or types of messages allowed or disallowed to be transmitted in the slot. A slot that allows an acknowledgement message to be transmitted may be configured to be shorter than a slots that allows other type of message. A device may transmit an acknowledgement message on the chronologically first reception slot assigned to the device with a slot identifier that indicates that an acknowledgement message is allowed to be transmitted in the slot. Thus, durations of slots may be tailored to accommodate the type of messages allowed to be transmitted in the slots, allowing acknowledgement messages to be transmitted in a TDD frame with minimal effect on the transmission throughput from a device.

FIG. 2H illustrates one example of a slot schedule 213 for the plurality of slots of the TDD frame 205. In the example of FIG. 2H, the slot schedule 213 may include a slot classifier for each slot the TDD frame 205 in addition to information that identifies which respective device(s) of the plurality of devices is assigned to each respective slot of the TDD frame 205. The slot classifier may indicate that one or more types of messages are allowed or disallowed to be transmitted in the respective slot. In one aspect, the slot classifier for a slot may indicate that a block acknowledgement may not be transmitted in the slot. If the slot with such a slot classifier is a transmission slot assigned to a device for transmitting, the slot may not be used by the assigned device for transmitting a block acknowledgement. If the slot with such a slot classifier is a reception slot assigned to a device for receiving, the slot may not be used by the assigned device for receiving a block acknowledgement from another device. In one aspect, the slot classifier for a slot may indicate that any frame may be transmitted in the slot. In one aspect, the slot classifier for a slot may indicate that a management frame or a control frame may not be transmitted in the slot. In one aspect, a management frame or a control frame may include an acknowledgement frame such as a normal acknowledgement to a MPDU or a QoS data frame, a block acknowledgement to an A-MPDU, or a probe response to a probe request.

The plurality of reception slots may include a first reception slot in time among the plurality of reception slots indicated by their respective slot classifier that one or more types of messages are allowed to be transmitted. For example, in FIG. 2H, the plurality of reception slots (i.e., slots 3, 4, 5) may all have a slot classifier indicating that any frame may be transmitted in the respective reception slots. As such, slot 3 may be a chronologically first slot assigned to device B among the plurality of reception slots indicated by the slot classifier that an acknowledgement message is allowed to be transmitted in the slot. During slot 0, device A transmits message 210 to device B. To acknowledge receipt of the message 210, device B may be configured to transmit the acknowledgement message 212 to device A during slot 3, the chronologically first reception slot assigned to device B with a slot classifier that indicates an acknowledgement message is allowed to be transmitted (e.g., a slot classifier that indicates any frame may be transmitted in the slot).

FIG. 2I illustrates another example use case of the slot schedule 213 with slot classifiers. In FIG. 2H, slot 3, which is assigned to device B, may have a slot classifier indicating that no block acknowledgement frame is allowed to be transmitted in the slot. Slot 4, assigned to device C, and slot 5, assigned to device B, both have a slot classifier indicating that any frame may be transmitted in the respective reception slots. As such, slot 5 may be a chronologically first slot assigned to device B among the plurality of reception slots indicated by the slot classifier that an acknowledgement message is allowed to be transmitted in the slot. During slot 0, device A transmits message 210 to device B. To acknowledge receipt of the message 210, device B may be configured to transmit the acknowledgement message 212 to device A during slot 5, the chronologically first reception slot assigned to device B with a slot classifier that indicates an acknowledgement message is allowed to be transmitted (e.g., a slot classifier that indicates any frame may be transmitted in the slot).

As described herein, the AP 104 and the STA 114 may include similar components. Therefore, reference to any component without the “A” or the “B” following the reference number refers to the component of either the AP 104 or the STA 114.

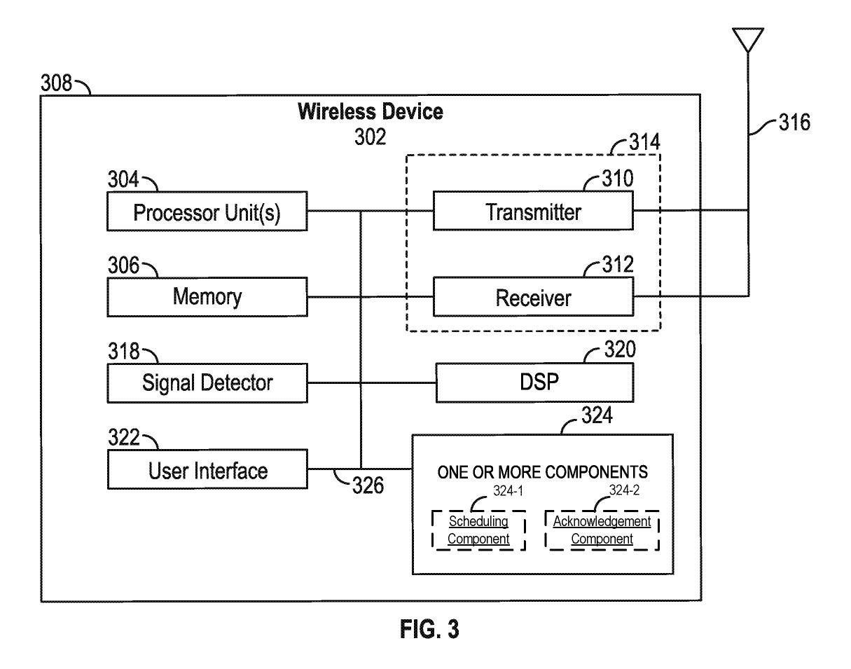

FIG. 3 shows an example functional block diagram of a wireless device 302 that may be configured to perform one or more techniques described herein. The wireless device 302 is an example of a device that may be configured to implement the various methods described herein. For example, the wireless device 302 may be the AP 104, the STA 114, or any other device configured to perform one or more techniques described herein.

The wireless device 302 may include a processor 304 which controls operation of the wireless device 302. The processor 304 may also be referred to as a central processing unit (CPU). In some examples, memory 306, which may include both read-only memory (ROM) and random access memory (RAM), may provide instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable (by the processor 304, for example) to implement the methods described herein.

The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 302 may also include a housing 308, and the wireless device 302 may include a transmitter 310 and/or a receiver 312 to allow transmission and reception of data between the wireless device 302 and a remote device. The transmitter 310 and the receiver 312 may be combined into a transceiver 314. An antenna 316 may be attached to the housing 308 and electrically coupled to the transceiver 314. The wireless device 302 may also include multiple transmitters, multiple receivers, multiple transceivers, and/or multiple antennas.

The wireless device 302 may also include a signal detector 318 that may be used to detect and quantify the level of signals received by the transceiver 314 or the receiver 312. The signal detector 318 may detect such signals as total energy, energy per subcarrier per symbol, power spectral density, and other signals. The wireless device 302 may also include a DSP 320 for use in processing signals. The DSP 320 may be configured to generate a packet for transmission. In some aspects, the packet may comprise a physical layer convergence procedure (PLCP) protocol data unit (PPDU).

The wireless device 302 may further comprise a user interface 322 in some aspects. The user interface 322 may comprise a keypad, a microphone, a speaker, and/or a display. The user interface 322 may include any element or component that conveys information to a user of the wireless device 302 and/or receives input from the user.

The various components of the wireless device 302 may be coupled together by a bus system 326. The bus system 326 may include a data bus, for example, as well as a power bus, a control signal bus, and a status signal bus in addition to the data bus. Components of the wireless device 302 may be coupled together or accept or provide inputs to each other using some other mechanism.

The wireless device 302 may further comprise one or more components 324. The one or more components 324 include one or more components described herein, such as with respect to FIG. 1. For example, the one or more components 324 may include a scheduling component 324-1 and an acknowledgement component 324-2. The scheduling component 324-1 may be configured to perform any processing (e.g., functions, steps, or the like) described herein with respect to the generation or processing of slot scheduling information. The acknowledgement component 324-2 may be configured to may be configured to perform any processing (e.g., functions, steps, or the like) described herein with respect to the generation of any acknowledgement message.

Although a number of separate components are illustrated in FIG. 3, one or more of the components may be combined or commonly implemented. For example, the processor 304 may be used to implement not only the functionality described above with respect to the processor 304, but also to implement the functionality described above with respect to the signal detector 318, the DSP 320, the user interface 322, and/or the one or more components 324. Further, each of the components illustrated in FIG. 3 may be implemented using a plurality of separate elements.

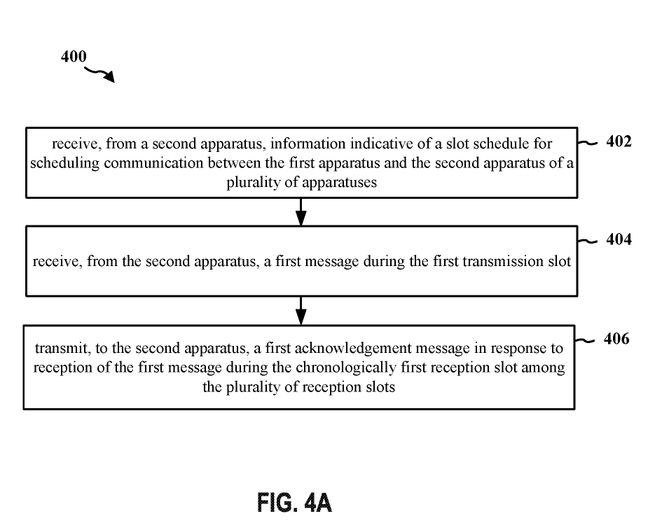

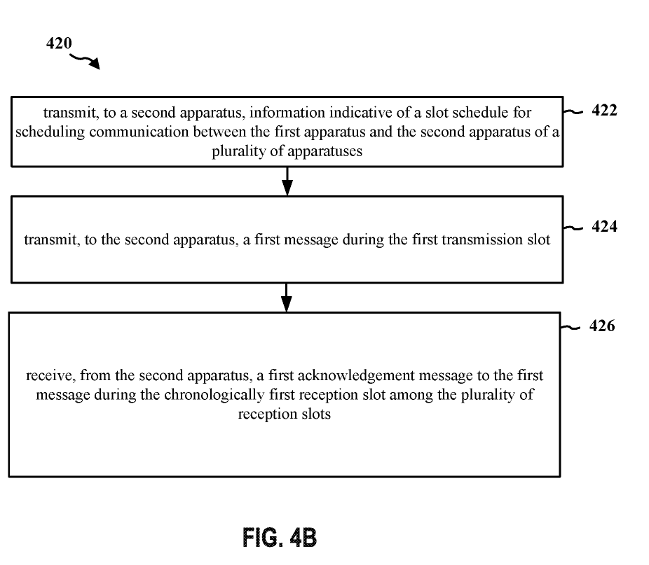

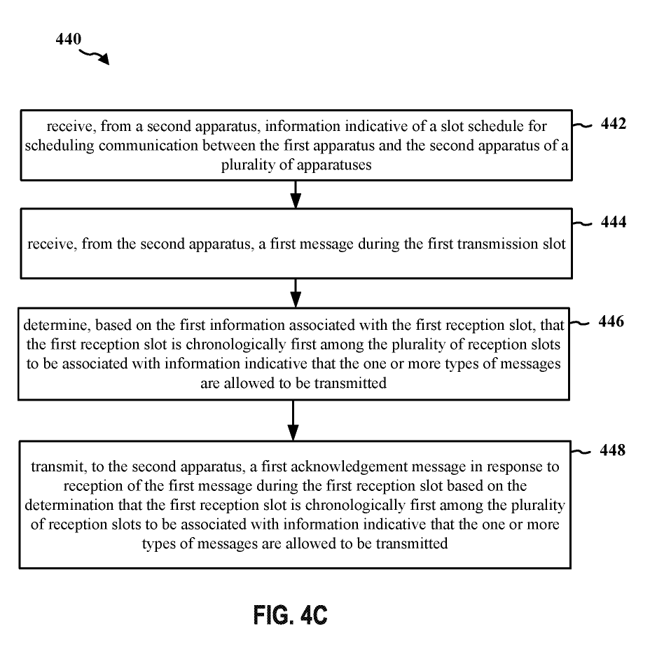

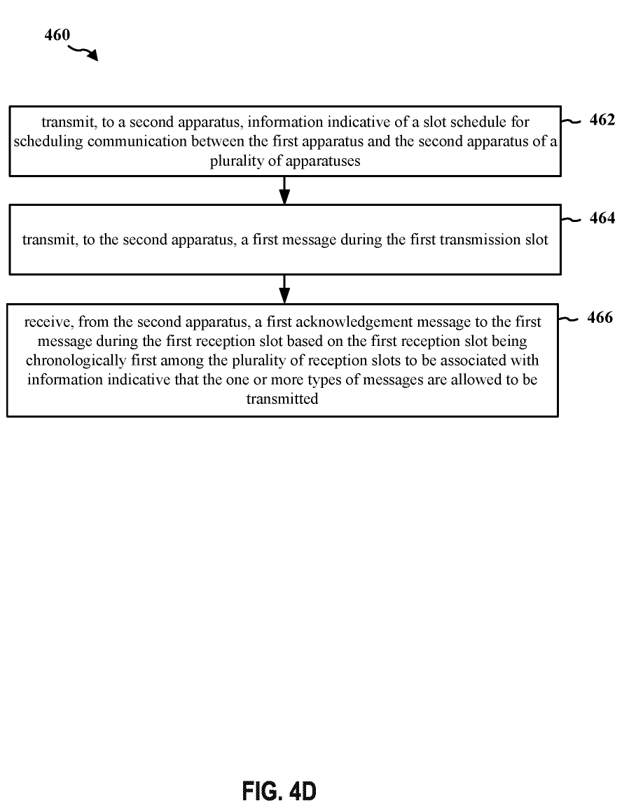

FIG. 4A is a flowchart of an example method 400 in accordance with the techniques described herein. The method 400 may be performed using a first apparatus (e.g., the AP 104, the wireless device 302, the STA 114, or any other device configured to perform one or more techniques described herein).

In the example of FIG. 4A, at block 402, the first apparatus may be configured to receive, from a second apparatus, information indicative of a slot schedule for scheduling communication between the first apparatus and the second apparatus of a plurality of apparatuses. The plurality of apparatuses may include the first apparatus and the second apparatus. The slot schedule may include a first transmission slot reserved for the second apparatus to transmit information to the first apparatus and a plurality of reception slots reserved for the first apparatus to transmit information to the second apparatus. The plurality of reception slots may include a chronologically first reception slot positioned before any other reception slot of the plurality of reception slots. At block 404, the first apparatus may be configured to receive, from the second apparatus, a first message during the first transmission slot. At block 406, the first apparatus may be configured to transmit, to the second apparatus, a first acknowledgement message in response to reception of the first message during the chronologically first reception slot among the plurality of reception slots.

FIG. 4B is a flowchart of an example method 420 in accordance with the techniques described herein. The method 420 may be performed using a first apparatus (e.g., the AP 104, the wireless device 302, the STA 114, or any other device configured to perform one or more techniques described herein).

In the example of FIG. 4B, at block 422, the first apparatus may be configured to transmit, to a second apparatus, information indicative of a slot schedule for scheduling communication between the first apparatus and the second apparatus of a plurality of apparatuses. The plurality of apparatuses may include the first apparatus and the second apparatus. The slot schedule may include a first transmission slot reserved for the first apparatus to transmit information to the second apparatus and a plurality of reception slots reserved for the second apparatus to transmit information to the first apparatus. The plurality of reception slots may include a chronologically first reception slot positioned before any other reception slot of the plurality of reception slots. At block 424, the first apparatus may be configured to transmit, to the second apparatus, a first message during the first transmission slot. At block 426, the first apparatus may be configured to receive, from the second apparatus, a first acknowledgement message to the first message during the chronologically first reception slot among the plurality of reception slots.

FIG. 4C is a flowchart of an example method 440 in accordance with the techniques described herein. The method 440 may be performed using a first apparatus (e.g., the AP 104, the wireless device 302, the STA 114, or any other device configured to perform one or more techniques described herein).

In the example of FIG. 4C, at block 442, the first apparatus may be configured to receive, from a second apparatus, information indicative of a slot schedule for scheduling communication between the first apparatus and the second apparatus of a plurality of apparatuses using a plurality of slots of a frame. The plurality of apparatuses may include the first apparatus and the second apparatus. The slot schedule may include a first transmission slot reserved for the second apparatus to transmit information to the first apparatus and a plurality of reception slots reserved for the first apparatus to transmit information to the second apparatus. The slot schedule may further include respective first information for each respective slot of the plurality of slots indicative of one or more types of messages allowed or disallowed to be transmitted in the respective slot. In one aspect, the first information for a slot may indicate that a block acknowledgement may not be transmitted in the slot. The slot may be a transmission slot or a reception slot. If the slot is a transmission slot assigned to the first apparatus to receive from the first apparatus, the first information for the slot may indicate that the slot may not be used for transmitting a block acknowledgement from the second apparatus to the first apparatus. If the slot is a reception slot assigned to the first apparatus to transmit to the first apparatus, the first information for the slot may indicate that the slot may not be used for transmitting a block acknowledgement from the first apparatus to the second apparatus. In one aspect, the first information for a slot may indicate that any frame may be transmitted in the slot. In one aspect, the first information for a slot may indicate that a management frame or a control frame may not be transmitted in the slot. In one aspect, a management frame or a control frame may include an acknowledgement frame such as a normal acknowledgement to a MPDU or a QoS data frame, a block acknowledgement to an A-MPDU, or a probe response to a probe request.

The plurality of reception slots may include a first reception slot in time among the plurality of reception slots indicated by their respective first information that one or more types of messages are allowed to be transmitted from the first apparatus to the second apparatus. For example, the first reception slot may be a chronologically first slot among the plurality of reception slots to be associated with the first information indicative that an acknowledgement message is allowed to be transmitted in the respective reception slots from the first apparatus to the second apparatus.

At block 444, the first apparatus may be configured to receive, from the second apparatus, a first message during the first transmission slot. The first transmission slot may be one transmission slot among a plurality of transmission slots indicated by their respective first information that any data are allowed to be transmitted in the slots. The first message may be a QoS data message, an A-MPDU, a MPDU, a probe request, an action frame, a management frame, a multi-user (MU) frame, a data packet, a data frame, etc.

At block 446, the first apparatus may be configured to determine, based on the first information associated with the first reception slot, that the first reception slot is chronologically first among the plurality of reception slots indicated by their respective first information as being allowed to transmit an acknowledgement message from the first apparatus to the second apparatus. That is, the first reception slot may be the earliest reception slot among the plurality of reception slots that are allowed to transmit an acknowledgement message from the first apparatus to the second apparatus. However, the first reception slot may not be the earliest reception slot among the plurality of reception slots assigned to the first apparatus. There may be positioned before the first reception slot one or more reception slots that are not allowed to transmit an acknowledgement message from the first apparatus to the second apparatus. In one aspect, the acknowledgement message may be a normal acknowledgement, a block acknowledgement, or a prober response.

At block 448, the first apparatus may be configured to transmit, to the second apparatus, a first acknowledgement message in response to reception of the first message during the first reception slot based on the determination that the first reception slot is chronologically first among the plurality of reception slots indicated by their respective first information as being allowed to transmit an acknowledgement message from the first apparatus to the second apparatus. As a result, if the first message received by the first apparatus from the second apparatus is a MPDU that solicits an immediate acknowledgement, an acknowledgement to the MPDU may be delayed to the first reception slot that is allowed to be used by the first apparatus for transmitting a block acknowledgement frame to the second apparatus.

FIG. 4D is a flowchart of an example method 460 in accordance with the techniques described herein. The method 460 may be performed using a first apparatus (e.g., the AP 104, the wireless device 302, the STA 114, or any other device configured to perform one or more techniques described herein).

In the example of FIG. 4D, at block 462, the apparatus may be configured to transmit, to a second apparatus, information indicative of a slot schedule for scheduling communication between the first apparatus and the second apparatus of a plurality of apparatuses using a plurality of slots of a frame. The plurality of apparatuses may include the first apparatus and the second apparatus The slot schedule may include a first transmission slot reserved for the first apparatus to transmit information to the second apparatus and a plurality of reception slots reserved for the second apparatus to transmit information to the first apparatus. The slot schedule may further include respective first information for each respective slot of the plurality of slots indicative of one or more types of messages allowed or disallowed to be transmitted in the respective slot. In one aspect, the first information for a slot may indicate that a block acknowledgement frame may not be transmitted in the slot. The slot may be a transmission slot or a reception slot. If the slot is a transmission slot assigned to the second apparatus to receive from the first apparatus, the first information for the slot may indicate that the slot may not be used for transmitting a block acknowledgement from the first apparatus to the second apparatus. If the slot is a reception slot assigned to the second apparatus to transmit to the first apparatus, the first information for the slot may indicate that the slot may not be used for transmitting a block acknowledgement from the second apparatus to the first apparatus. In one aspect, the first information for a slot may indicate that any frame may be transmitted in the slot. In one aspect, the first information for a slot may indicate that a control frame or a management frame may not be transmitted in the slot. In one aspect, a management frame or a control frame may include an acknowledgement frame such as a normal acknowledgement to a MPDU or a QoS data frame, a block acknowledgement to an A-MPDU, or a probe response to a probe request.

The plurality of reception slots may include a first reception slot in time among the plurality of reception slots indicated by their respective first information that one or more types of messages are allowed to be transmitted from the second apparatus to the first apparatus. For example, the first reception slot may be a chronologically first slot among the plurality of reception slots to be associated with the first information indicative that an acknowledgement message is allowed to be transmitted in the respective reception slots from the second apparatus to the first apparatus. That is, the first reception slot may be the earliest reception slot among the plurality of reception slots that are allowed to transmit an acknowledgement message from the second apparatus to the first apparatus. However, the first reception slot may not be the earliest reception slot among the plurality of reception slots assigned to the second device. There may be positioned before the first reception slot one or more reception slots that are not allowed to transmit an acknowledgement message from the second apparatus to the first apparatus. In one aspect, the acknowledgement message may be a normal acknowledgement, a block acknowledgement, or a probe response.

At block 464, the first apparatus may be configured to transmit, to the second apparatus, a first message during the first transmission slot. The first transmission slot may be one transmission slot among a plurality of transmission slots indicated by their respective first information that any data are allowed to be transmitted in the slots. The first message may be a QoS data message, an A-MPDU, a MPDU, a probe request, an action frame, a management frame, a multi-user (MU) frame, a data packet, a data frame, etc.

At block 466, the first apparatus may be configured to receive, from the second apparatus, a first acknowledgement message to the first message during the first reception slot based on the first reception slot being chronologically first among the plurality of reception slots indicated by their respective first information as being allowed to transmit an acknowledgement message from the second apparatus to the first apparatus. As a result, if the first message transmitted by the first apparatus to the second apparatus is a MPDU that solicits an immediate acknowledgement, an acknowledgement to the MPDU may be delayed to the first reception slot that is allowed to be used by the second apparatus for transmitting a block acknowledgement frame to the first apparatus.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method of wireless communication, comprising:
receiving, by a first device from a second device a slot schedule for scheduling communication between the first device and the second device of a plurality of devices using a plurality of slots of a frame, wherein the slot schedule includes respective first information for each respective slot of the plurality of slots indicating one or more types of messages allowed or disallowed to be transmitted in the respective slot, wherein the slot schedule includes a first transmission slot reserved for the second device to transmit information to the first device and a plurality of reception slots reserved for the first device to transmit information to the second device;
determining, by the first device based on the slot schedule, a chronologically first reception slot, wherein the chronologically first reception slot is a first reception slot in time among the plurality of reception slots indicated by the respective first information as being allowed to be used by the first device to transmit an acknowledgement message to the second device;
receiving, by the first device from the second device, a first message during the first transmission slot; and
transmitting, by the first device to the second device, a first acknowledgement message in response to reception of the first message during the chronologically first reception slot.

2. The method of claim 1, wherein the respective first information for each respective slot includes one of:
a respective first value indicating that any type of message is allowed to be transmitted in the respective slot corresponding to the respective first value; or
a respective second value indicating that a block acknowledgement message is disallowed to be transmitted in the respective slot corresponding to the respective second value.

3. The method of claim 2, wherein the first information corresponding to the chronologically first reception slot is the first value.

4. The method of claim 3, wherein transmitting, by the first device to the second device, the first acknowledgement message in response to reception of the first message comprises:
transmitting, by the first device to the second device, a first block acknowledgement message during the chronologically first reception slot among the plurality of reception slots allowed to transmit a block acknowledgement message.

5. The method of claim 3, wherein the plurality of reception slots includes at least one reception slot positioned before the chronologically first reception slot, wherein the first information corresponding to the at least one reception slot positioned before the chronologically first reception slot is the second value, and wherein the chronologically first reception slot is positioned before any other reception slot of the plurality of reception slots that have respective first information being the first value.

6. The method of claim 1, wherein the respective first information for each respective slot includes one of:
a respective first value indicating that any type of message is allowed to be transmitted in the respective slot corresponding to the respective first value; or
a respective second value indicating that a management frame or a control frame is disallowed to be transmitted in the respective slot corresponding to the respective second value.

7. The method of claim 1, wherein the first message is one of: a quality of service (QoS) data message, an aggregated medium access control (MAC) protocol data unit (A-MPDU), a MAC protocol data unit (MPDU), a probe request, an action frame, a management frame, a Multi-User (MU) frame, a data packet, or a data frame, and wherein the first acknowledgement message is one of: an acknowledgement, a block acknowledgement, or a probe response.

8. The method of claim 1, further comprising receiving by the first device from the second device information indicative of a slot structure of the plurality of slots, wherein the information indicative of the slot structure includes second information indicative of a number of slots included in the frame and third information indicative of a respective time period corresponding to each slot of the number of slots included in the frame, and wherein the slot schedule includes fourth information that identifies which respective device of the plurality of devices is assigned to each respective slot of the plurality of slots.

9. A method of wireless communication, comprising:
transmitting, by a first device to a second device a slot schedule for scheduling communication between the first device and the second device of a plurality of devices using a plurality of slots of a frame, wherein the slot schedule includes respective first information for each respective slot of the plurality of slots indicating one or more types of messages allowed or disallowed to be transmitted in the respective slot, wherein the slot schedule includes a first transmission slot reserved for the first device to transmit information to the second device and a plurality of reception slots reserved for the second device to transmit information to the first device;
transmitting, by the first device to the second device, a first message during the first transmission slot; and
receiving, by the first device from the second device, a first acknowledgement message in response to the first message during a chronologically first reception slot, wherein the chronologically first reception slot is a first reception slot in time among the plurality of reception slots indicated by the respective first information as being allowed to be used by the second device to transmit an acknowledgement message to the first device.

10. The method of claim 9, wherein the respective first information for each respective slot includes one of:
a respective first value indicating that any type of message is allowed to be transmitted in the respective slot corresponding to the respective first value; or
a respective second value indicating that a block acknowledgement message is disallowed to be transmitted in the respective slot corresponding to the respective second value.

11. The method of claim 10, wherein the first information corresponding to the chronologically first reception slot is the first value.

12. The method of claim 11, wherein receiving, by the first device from the second device, the first acknowledgement message in response to the first message comprises:
receiving, by the first device from the second device, a first block acknowledgement message during the chronologically first reception slot among the plurality of reception slots allowed to transmit a block acknowledgement message.

13. The method of claim 11, wherein the plurality of reception slots includes at least one reception slot positioned before the chronologically first reception slot, wherein the first information corresponding to the at least one reception slot positioned before the chronologically first reception slot is the second value, and wherein the chronologically first reception slot is positioned before any other reception slot of the plurality of reception slots that have respective first information being the first value.

14. The method of claim 9, wherein the respective first information for each respective slot includes one of:
a respective first value indicating that any type of message is allowed to be transmitted in the respective slot corresponding to the respective first value; or
a respective second value indicating that a management frame or a control frame is disallowed to be transmitted in the respective slot corresponding to the respective second value.

15. The method of claim 9, wherein the first message is one of: a quality of service (QoS) data message, an aggregated medium access control (MAC) protocol data unit (A-MPDU), a MAC protocol data unit (MPDU), a probe request, an action frame, a management frame, a Multi-User (MU) frame, a data packet, or a data frame, and wherein the first acknowledgement message is one of: an acknowledgement, a block acknowledgement, or a probe response.

16. An wireless communication device comprising:
at least one antenna;
at least one processor; and
at least one memory communicatively coupled with the at least one processor and storing processor readable code that, when executed by the at least one processor, causes the wireless communication device to:
receive from a second device a slot schedule for scheduling communication between the wireless communication device and the second device using a plurality of slots of a frame, wherein the slot schedule includes respective first information for each respective slot of the plurality of slots indicating one or more types of messages allowed or disallowed to be transmitted in the respective slot, wherein the slot schedule includes a first transmission slot reserved for the second device to transmit information to the wireless communication device and a plurality of reception slots reserved for the wireless communication device to transmit information to the second device;
determine based on the slot schedule a chronologically first reception slot, wherein the chronologically first reception slot is a first reception slot in time among the plurality of reception slots indicated by the respective first information as being allowed to be used by the first device to transmit an acknowledgement message to the second device;
receive from the second device a first message during the first transmission slot; and
transmit to the second device a first acknowledgement message in response to reception of the first message during the chronologically first reception slot.

17. The wireless communication device of claim 16, wherein the respective first information for each respective slot includes one of:
a respective first value indicating that any type of message is allowed to be transmitted in the respective slot corresponding to the respective first value; or
a respective second value indicating that a block acknowledgement message is disallowed to be transmitted in the respective slot corresponding to the respective second value.

18. The wireless communication device of claim 17, wherein the first information corresponding to the chronologically first reception slot is the first value.

19. The wireless communication device of claim 18, wherein to transmit to the second device the first acknowledgement message in response to reception of the first message during the chronologically first reception slot, the at least one processor when executing the processor readable code further causes the wireless communication device to transmit to the second device a first block acknowledgement message during the chronologically first reception slot among the plurality of reception slots allowed to transmit a block acknowledgement message.

20. The wireless communication device of claim 18, wherein the plurality of reception slots includes at least one reception slot positioned before the chronologically first reception slot, wherein the first information corresponding to the at least one reception slot positioned before the chronologically first reception slot is the second value, and wherein the chronologically first reception slot is positioned before any other reception slot of the plurality of reception slots that have respective first information being the first value.

21. The wireless communication device of claim 16, wherein the respective first information for each respective slot includes one of:
a respective first value indicating that any type of message is allowed to be transmitted in the respective slot corresponding to the respective first value; or
a respective second value indicating that a management frame or a control frame is disallowed to be transmitted in the respective slot corresponding to the respective second value.

22. The wireless communication device of claim 16, wherein the first message is one of: a quality of service (QoS) data message, an aggregated medium access control (MAC) protocol data unit (A-MPDU), a MAC protocol data unit (MPDU), a probe request, an action frame, a management frame, a Multi-User (MU) frame, a data packet, or a data frame, and wherein the first acknowledgement message is one of: an acknowledgement, a block acknowledgement, or a probe response.

23. The wireless communication device of claim 16, wherein the processor readable code when executed by the at least one processor further causes the wireless communication device to receive from the second device information indicative of a slot structure of the plurality of slots, wherein the information indicative of the slot structure includes second information indicative of a number of slots included in the frame and third information indicative of a respective time period corresponding to each slot of the number of slots included in the frame, and wherein the slot schedule includes fourth information that identifies which respective device of a plurality of devices is assigned to each respective slot of the plurality of slots.

24. An wireless communication device comprising:
at least one antenna;
at least one processor; and
at least one memory communicatively coupled with the at least one processor and storing processor readable code that, when executed by the at least one processor, causes the wireless communication device to:
transmit to a second device a slot schedule for scheduling communication between the wireless communication device and the second device using a plurality of slots of a frame, wherein the slot schedule includes respective first information for each respective slot of the plurality of slots indicating one or more types of messages allowed or disallowed to be transmitted in the respective slot, wherein the slot schedule includes a first transmission slot reserved for the wireless communication device to transmit information to the second device and a plurality of reception slots reserved for the second device to transmit information to the wireless communication device;
transmit to the second device a first message during the first transmission slot; and
receive from the second device a first acknowledgement message in response to the first message during a chronologically first reception slot, wherein the chronologically first reception slot is a first reception slot in time among the plurality of reception slots indicated by the respective first information as being allowed to be used by the second device to transmit an acknowledgement message to the first device.

25. The wireless communication device of claim 24, wherein the respective first information for each respective slot includes one of:
a respective first value indicating that any type of message is allowed to be transmitted in the respective slot corresponding to the respective first value; or
a respective second value indicating that a block acknowledgement message is disallowed to be transmitted in the respective slot corresponding to the respective second value.

26. The wireless communication device of claim 25, wherein the first information corresponding to the chronologically first reception slot is the first value.

27. The wireless communication device of claim 26, wherein to receive from the second device the first acknowledgement message in response to the first message during a chronologically first reception slot, the at least one processor when executing the processor readable code further causes the wireless communication device to receive from the second device a first block acknowledgement message during the chronologically first reception slot among the plurality of reception slots allowed to transmit a block acknowledgement message.

28. The wireless communication device of claim 26, wherein the plurality of reception slots includes at least one reception slot positioned before the chronologically first reception slot, wherein the first information corresponding to the at least one reception slot positioned before the chronologically first reception slot is the second value, and wherein the chronologically first reception slot is positioned before any other reception slot of the plurality of reception slots that have respective first information being the first value.

29. The wireless communication device of claim 24, wherein the respective first information for each respective slot includes one of:
a respective first value indicating that any type of message is allowed to be transmitted in the respective slot corresponding to the respective first value; or
a respective second value indicating that a management frame or a control frame is disallowed to be transmitted in the respective slot corresponding to the respective second value.

30. The wireless communication device of claim 24, wherein the first message is one of: a quality of service (QoS) data message, an aggregated medium access control (MAC) protocol data unit (A-MPDU), a MAC protocol data unit (MPDU), a probe request, an action frame, a management frame, a Multi-User (MU) frame, a data packet, or a data frame, and wherein the first acknowledgement message is one of: an acknowledgement, a block acknowledgement, or a probe response.
